(19) United States
(12) Patent Application Publication
(10) Pub. No.: US 2007/0094657 A1
(43) Pub. Date: Apr. 26, 2007

(54) Method and apparatus for installing an application into a device

(75) Inventor: Channa D. Jayasinghe, Houston, TX (US)

Correspondence Address: CYBERONICS, INC., LEGAL DEPARTMENT, 6TH FLOOR, 100 CYBERONICS BOULEVARD, HOUSTON, TX, 77058, US

(73) Assignee: CYBERONICS, INC.

(21) Appl. No.: 11/259,164

(22) Filed: Oct. 25, 2005

(51) Int. Cl. G06F 9/445

(52) U.S. Cl. 717/174

(57) ABSTRACT

A method and an apparatus for installing an application into a device in communication with an implantable medical device (IMD) are provided. A boot sequence of the device is performed. A pre-installation configuration of the device is performed. The pre-installation configuration comprises locating a set-up key relating to a non-volatile memory of the device and setting up a portion of the non-volatile memory using the set-up key to define a named portion of the non-volatile memory. The application is installed into the named portion of the non-volatile memory.

### BACKGROUND OF THE INVENTION

1. Field of the Invention

This invention relates generally to using an external device to communicate with an implantable medical device and, more particularly, to methods, apparatuses and systems for installing an application in the external device.

2. Description of the Related Art

There have been many improvements over the last several decades in medical treatments for disorders of the nervous system, such as epilepsy and other motor disorders, and abnormal neural discharge disorders. One of the more recently available treatments involves the application of an electrical signal to reduce various symptoms or effects caused by such neural disorders. For example, electrical signals have been successfully applied at strategic locations in the human body to provide various benefits, including reducing occurrences of seizures and/or improving or ameliorating other conditions. A particular example of such a treatment regimen involves applying an electrical signal to the vagus nerve of the human body to reduce or eliminate epileptic seizures, as described in U.S. Pat. Nos. 4,702,254, 4,867,164, and 5,025,807 to Dr. Jacob Zabara, which are hereby incorporated in their entirety herein by reference in this specification. Electrical stimulation of the vagus nerve (hereinafter referred to as vagus nerve stimulation therapy or VNS) may be provided by implanting an electrical device underneath the skin of a patient and performing a detection and electrical stimulation process. This type of stimulation is generally referred to as “active”, “feedback”, or “triggered” stimulation. Alternatively, the system may operate without a detection system once the patient has been diagnosed with epilepsy, and may periodically apply a series of electrical pulses to the vagus (or other cranial) nerve intermittently throughout the day, or over another predetermined time interval. This type of stimulation is generally referred to as “passive”, “non-feedback”, or “prophylactic”, stimulation. The stimulation may be applied by an implantable medical device (IMD) that is implanted within the patient's body.

External devices, such as a handheld device, may be used to communicate with the implantable device. This communication may relate to acquiring status information from the IMD, programming it, and/or affecting its operation in a variety of manners. There have been many advances in communications between an external unit and an IMD. A number of types of external devices may be used to communicate with the implantable device. These devices may include handheld devices e.g., personal digital assistants (PDAs). In other embodiments, laptop or desktop computers may be used. Where handheld devices are employed, operations of the handheld devices are generally controlled by operating systems specifically designed for such portable machines. One such operating system is the Microsoft Windows® Mobile™ software product offered by Microsoft Corporation.

There are a number of manufacturers of handheld devices. Many of these handheld devices are capable of operating under a standard operating system, such as an operating system offered by Microsoft Corporation. However, various handheld device manufacturers implement the software and/or hardware structures in different manners. One of the problems associated with the state-of-the-art is that developers find it challenging to develop common installation solutions that could be implemented across a broad range of handheld devices. Another problem is that there may be a great deal of complexity in installing certain software products into the handheld machines in a standard manner. For example, many handheld device manufacturers use different naming conventions for the respective persistent storage locations in the handheld devices. As used herein, the terms “persistent storage” and “persistent memory” refer to non-volatile memory that can be both read and written. The different naming conventions of the persistent storage used by manufacturers causes difficulties in installing software products into the persistent storage using a common installation file. For example, using a uniform installation file, such as a cabinet file (.CAB file), to install software products into the persistent storage of the handheld device is made difficult due to the wide range of configurations present in various handheld devices.

Among the solutions proposed to overcome some of the problems of state-of-the-art PDAs is installing software products directly onto the non-persistent storage memory, such as RAM based memory, in the handheld device. One problem with this solution is that the installed software is vulnerable since data stored in non-persistent storage memory may be lost when there is power interruption, such as a main battery failure or a backup battery failure. These types of power interruptions could occur frequently in handheld devices.

Another solution that has been proposed is to install applications into non-persistent memory and administer a regularly scheduled backup to reduce the possibility of data loss in the case of a power interruption. However, one of the problems associated with this solution is that an external and costly storage may be required. Another problem is that various resources must be devoted to such backup utilities—resources that may be better utilized for other tasks. For mission-critical software products, the risk of losing data, despite the backup utility, may be unacceptable.

Another solution to the problem of installing software into persistent storage locations in handheld devices associated with IMDs is to pre-install software in the handheld device before delivering it to a user. However, this solution is substantially impractical since handheld device users as well as manufacturers are spread across the globe and IMD manufacturers are frequently in different locations from handheld device manufacturers, making pre-installation difficult, inconvenient, or impossible. Other solutions that have been proposed include maintaining a separate .CAB file for each different machine class. However, since there are already many types of external devices, and the number of handheld manufacturers is growing, this process would be very inefficient, cumbersome, and costly. The cost associated with generating and/or maintaining a custom .CAB file for each type of possible external device would be very high. There is a need for an efficient manner of installing software products into handheld devices in a uniform or machine transparent manner.

The present invention is directed to overcoming, or at least reducing, the effects of one or more of the problems set forth above.

### SUMMARY OF THE INVENTION

In one aspect of the present invention, a method for installing an application into an external device in communication with an IMD is provided. A control access parameter relating to a persistent memory of the device is located. A portion of the persistent memory is defined using the control access parameter to provide a defined portion of the persistent memory. The application is installed into the defined portion of the persistent memory.

In another aspect of the present invention, a method for installing an application into an external device in communication with an IMD is provided. A boot sequence of the device is performed. A pre-installation configuration of the device is performed. The pre-installation configuration comprises locating a set-up key relating to a non-volatile memory of the device and setting up a portion of the non-volatile memory using the set-up key to define a named portion of the non-volatile memory. The application is installed into the named portion of the non-volatile memory.

In yet another aspect, the present invention comprises an external device for installing an application into an external device in communication with an IMD. The external device of the present invention includes an input/output device adapted to receive an instruction to install an application into the external device. The external device also includes a non-volatile memory operatively adapted to receive an installation of the application. The external device also includes a controller that is adapted to perform the installation of the application into the external device. The controller is also adapted to locate a set-up key associated with the non-volatile memory. The controller is also adapted to assign a memory name key-value to a portion of the non-volatile memory using the set-up key and install the application into the portion of the non-volatile memory.

In another aspect, the present invention includes an implantable medical device system for providing an electrical or electromagnetic stimulation signal to a patient's body. The system of the present invention includes an IMD, capable of providing an electrical and/or an electromagnetic stimulation to a portion of a patient's body. The system also includes an external device capable of communicating with the IMD. The external device comprises an input/output device capable of receiving an instruction to install an application for providing communications between the IMD and the external device. The external device also comprises a non-volatile memory to receive an installation of the application, and a controller adapted to perform the installation of the application into the external device. The controller is also adapted to locate a set-up key associated with the non-volatile memory. The controller is further adapted to assign a memory name key-value to a portion of the non-volatile memory using the set-up key and install the application into the portion of the non-volatile memory.

In yet another aspect of the present invention, a computer readable program storage device encoded with instructions is provided for installing an application into a device. The computer readable program storage device is encoded with instructions that, when executed by a computer, performs a method comprising: locating a control access parameter relating to a persistent memory of the device; defining a portion of the persistent memory using the control access parameter to provide a defined portion of the persistent memory; and installing the application into the defined portion of the persistent memory.

### BRIEF DESCRIPTION OF THE DRAWINGS

The invention may be understood by reference to the following description taken in conjunction with the accompanying drawings, in which like reference numerals identify like elements, and in which:

FIGS. 1A-1D provide stylized diagrams of an implantable medical device implanted into a patient's body for providing stimulation to a portion of the patient's body, in accordance with one illustrative embodiment of the present invention;

FIG. 2 is a block diagram of an implantable medical device and an external unit that communicates with the implantable medical device, for example, to program the implantable medical device, in accordance with one illustrative embodiment of the present invention;

FIG. 3 is a block diagram of one embodiment of the external unit of FIG. 2;

FIG. 4 is a block diagram of an external unit in communication with a configuration controller, in accordance with one illustrative embodiment of the present invention;

FIG. 5 illustrates a boot device of the external unit of FIG. 4, in accordance with one illustrative embodiment of the present invention;

FIG. 6 is a block diagram of an installation unit of the external unit of FIG. 4, in accordance with one illustrative embodiment of the present invention;

FIG. 7 is a flowchart of the installation process for installing an application into an external device, in accordance with one illustrative embodiment of the present invention;

FIG. 8 is a more detailed flowchart depiction of the step of performing a boot sequence of FIG. 7, in accordance with one illustrative embodiment of the present invention;

FIG. 9 is a more detailed flowchart depiction of a pre-installation configuration process of FIG. 7, in accordance with one illustrative embodiment of the present invention; and

FIG. 10 is a more detailed flowchart depiction of the steps of performing an installation process of FIG. 7, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the present invention are described herein. In the interest of clarity, not all features of an actual implementation are described in this specification. In the development of any such actual embodiment, numerous implementation-specific decisions must be made to achieve the design-specific goals, which will vary from one implementation to another. It will be appreciated that such a development effort, while possibly complex and time-consuming, would nevertheless be a routine undertaking for persons of ordinary skill in the art having the benefit of this disclosure.

Embodiments of the present invention provide for installing a software product into a device. In one embodiment the device is an external device that is capable of communicating with an implantable medical device (IMD). A software product may be installed into the external unit. The software product may be used to configure the external device to facilitate communications between the external device and the IMD. Although not so limited, the external unit may be a handheld device and/or a portable device, such as a PDA, a cellular phone, a laptop computer, etc.

Embodiments of the present invention provide for modifying a system associated with the external unit to facilitate the installation of a software product into the memory portion of the external unit. For example, embodiments of the present invention may be employed to install software in various types of handheld devices. Utilizing embodiments of the present invention, applications may be efficiently installed into various external units, such as handheld devices, that are controlled by an operating system, such as Microsoft's Windows® Mobile™ offered by Microsoft Corporation of Redmond, Wash,, U.S.A. Using the embodiments of the present invention, a single cabinet (.CAB) file may be used to install a software product on a variety of external devices with different pre-configurations. Utilizing embodiments of the present invention, various software products that are useful in providing communications between an external unit and an IMD may be installed into a wide variety of external unit types in an efficient manner, e.g., using a single .CAB file.

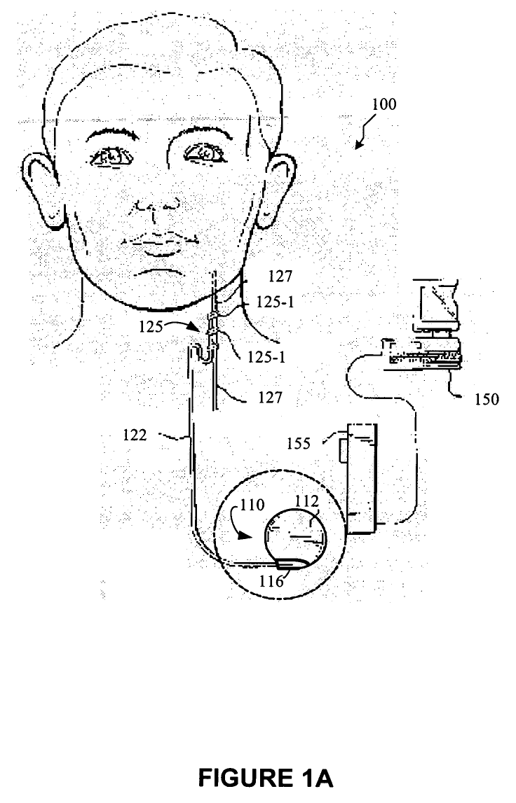

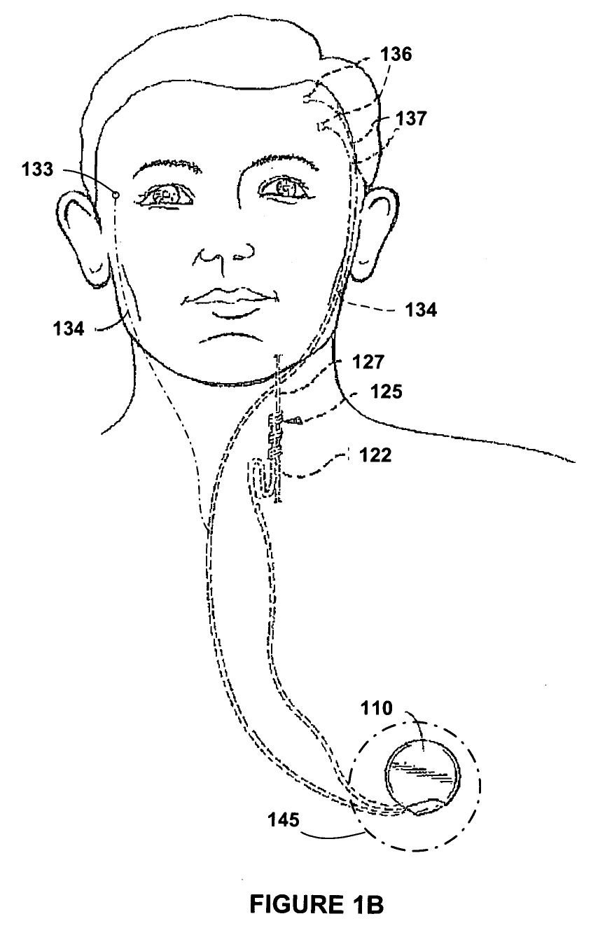

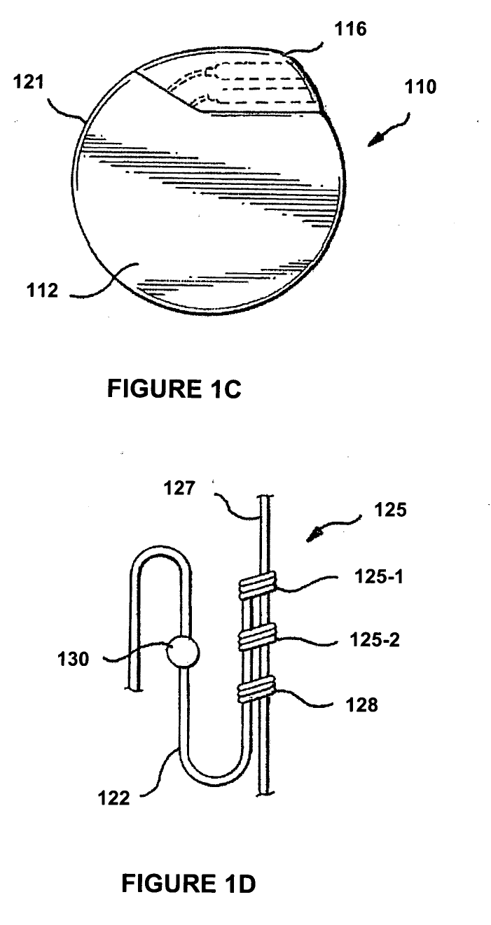

An exemplary IMD that may be in communication with an external device comprising embodiments of the present invention is described below. FIGS. 1A-1D depict a stylized implantable medical system 100 for implementing one or more embodiments of the present invention. FIGS. 1A-1D illustrate an electrical signal generator 110 having main body 112 comprising a case or shell 121 (FIG. 1A) with a header 116 (FIG. 1C) for connecting to leads 122. The generator 110 is implanted in the patient's chest in a pocket or cavity formed by the implanting surgeon just below the skin (indicated by a dotted line 145, FIG. 1B), similar to the implantation procedure for a pacemaker pulse generator.

A stimulating nerve electrode assembly 125, preferably comprising an electrode pair, is conductively connected to the distal end of an insulated, electrically conductive lead assembly 122, which preferably comprises a pair of lead wires (one wire for each electrode of an electrode pair). Lead assembly 122 is attached at its proximal end to connectors on the header 116 (FIG. 1C) on case 121. The electrode assembly 125 may be surgically coupled to a vagus nerve 127 in the patient's neck or at another location, e.g., near the patient's diaphragm. Other cranial nerves may also be used to deliver the electrical neurostimulation signal. The electrode assembly 125 preferably comprises a bipolar stimulating electrode pair 125-1, 125-2 (FIG. 1D), such as the electrode pair described in U.S. Pat. No. 4,573,481 issued Mar. 4, 1986 to Bullara. Suitable electrode assemblies are available from Cyberonics, Inc., Houston, Tex., USA as the Model 302 electrode assembly. However, persons of skill in the art will appreciate that many electrode designs could be used in the present invention. The two electrodes are preferably wrapped about the vagus nerve, and the electrode assembly 125 may be secured to the nerve 127 by a spiral anchoring tether 128 (FIG. 1D) such as that disclosed in U.S. Pat. No. 4,979,511 issued Dec. 25, 1990 to Reese S. Terry, Jr. and assigned to the same assignee as the instant application. Lead assembly 122 is secured, while retaining the ability to flex with movement of the chest and neck, by a suture connection 130 to nearby tissue (FIG. 1D).

In one embodiment, the open helical design of the electrode assembly 125 (described in detail in the above-cited Bullara patent), which is self-sizing and flexible, minimizes mechanical trauma to the nerve and allows body fluid interchange with the nerve. The electrode assembly 125 preferably conforms to the shape of the nerve, providing a low stimulation threshold by allowing a large stimulation contact area with the nerve. Structurally, the electrode assembly 125 comprises two electrode ribbons (not shown), of a conductive material such as platinum, iridium, platinum-iridium alloys, and/or oxides of the foregoing. The electrode ribbons are individually bonded to an inside surface of an elastomeric body portion of the two spiral electrodes 125-1 and 125-2 (FIG. 1D), which may comprise two spiral loops of a three-loop helical assembly. The lead assembly 122 may comprise two distinct lead wires or a coaxial cable whose two conductive elements are respectively coupled to one of the conductive electrode ribbons. One suitable method of coupling the lead wires or cable to the electrodes 125-1, 125-2 comprises a spacer assembly such as that disclosed in U.S. Pat. No. 5,531,778, although other known coupling techniques may be used.

The elastomeric body portion of each loop is preferably composed of silicone rubber, and the third loop 128 (which typically has no electrode) acts as the anchoring tether for the electrode assembly 125.

In certain embodiments of the invention, sensors such as eye movement sensing electrodes 133 (FIG. 1B) may be implanted at or near an outer periphery of each eye socket in a suitable location to sense muscle movement or actual eye movement. The electrodes 133 may be electrically connected to leads 134 implanted via a catheter or other suitable means (not shown) and extending along the jaw line through the neck and chest tissue to the header 116 of the electrical pulse generator 110. When included in systems of the present invention, the sensing electrodes 133 may be utilized for detecting rapid eye movement (REM) in a pattern indicative of a disorder to be treated, as described in greater detail below. The detected indication of the disorder can be used to trigger active stimulation.

Other sensor arrangements may alternatively or additionally be employed to trigger active stimulation. Referring again to FIG. 1B, electroencephalograph (EEG) sensing electrodes 136 may optionally be implanted and placed in spaced-apart relation on the skull, and connected to leads 137 implanted and extending along the scalp and temple, and then connected to the electrical pulse generator 110 along the same path and in the same manner as described above for the eye movement electrode leads 134.

In alternative embodiments, temperature sensing elements and/or heart rate sensor elements may be employed to trigger active stimulation. In addition to active stimulation incorporating sensor elements, other embodiments of the present invention utilize passive stimulation to deliver a continuous, periodic or intermittent electrical signal (each of which constitutes a form of continual application of the signal) to the vagus nerve according to a programmed on/off duty cycle without the use of sensors to trigger therapy delivery. Both passive and active stimulation may be combined or delivered by a single IMD according to the present invention. Either or both modes may be appropriate to treat the particular disorder diagnosed in the case of a specific patient under observation.

The electrical pulse generator 110 may be programmed with an external computer 150 using programming software of the type copyrighted by the assignee of the instant application with the Register of Copyrights, Library of Congress, or other suitable software based on the description herein, and a programming wand 155 to facilitate radio frequency (RF) communication between the computer 150 (FIG. 1A) and the pulse generator 110. The wand 155 and software permit non-invasive communication with the generator 110 after the latter is implanted. The wand 155 is preferably powered by internal batteries, and provided with a “power on” light to indicate sufficient power for communication. Another indicator light may be provided to show that data transmission is occurring between the wand and the generator.

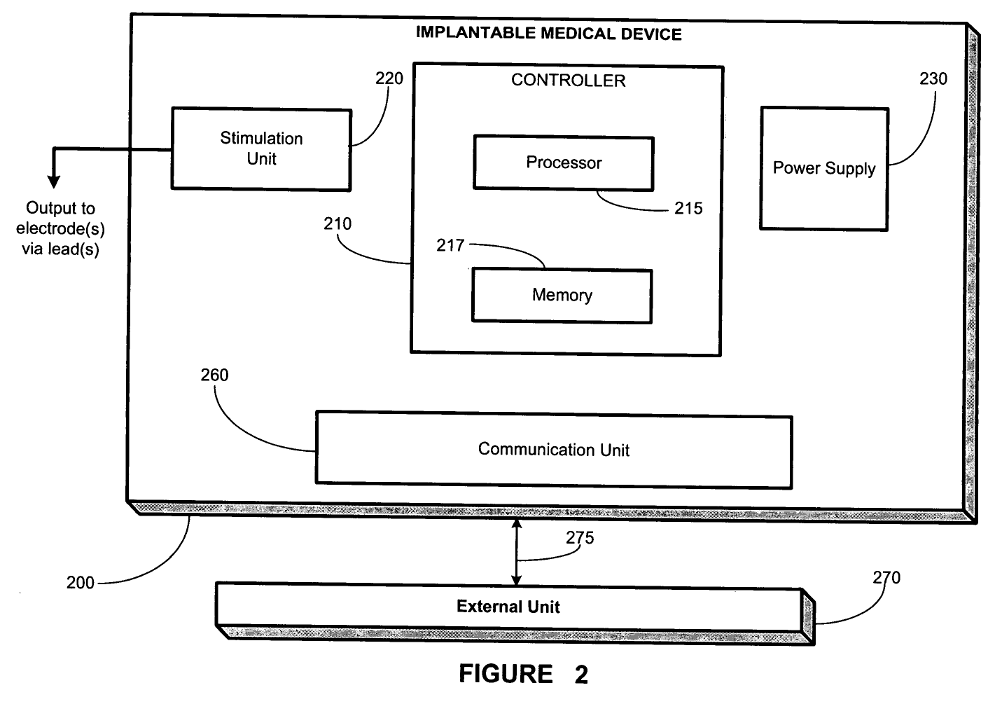

Turning now to FIG. 2, a block diagram is provided depicting an implantable medical device (IMD) 200 and an external device 270, in accordance with one illustrative embodiment of the present invention. The IMD 200 may be used to provide electrical stimulation to body tissue, such as nerve tissue, to treat various disorders, such as epilepsy, depression, bulimia, etc. The IMD 200 may be used to treat neuromuscular, neuropsychiatric, cognitive, autonomic, and/or sensory disorders. The IMD 200 may be coupled to various leads, such as lead assembly 122, as shown in FIG. 1. Electrical neurostimulation signals from the IMD 200 may be transmitted via the leads 122 to stimulation electrodes associated with the electrode assembly 125. In addition, signals from sensors may be transmitted to the IMD 200 by leads, such as leads 134 and 137.

The implantable medical device 200 may comprise a controller 210 that is capable of controlling various aspects of the operation of the MD 200. The controller 210 is capable of receiving internal data and/or external data and performing stimulation of various portions of the human body. For example, the controller 210 may receive manual instructions from an operator externally, or it may perform stimulation based on internal calculations and protocols programmed into or resident in internal memory 217. The controller 210 is capable of affecting substantially all functions of the IMD 200.

The controller 210 may comprise various components, such as a processor 215, a memory 217, and other structures conventional known to those skilled having benefit of the present disclosure. The processor 215 may comprise one or more microcontrollers, microprocessors, etc., capable of executing a variety of software components. The memory 217 may comprise various memory portions where a number of types of data (e.g., internal data, external data instructions, software codes, status data, diagnostic data, etc.) may be stored and retrieved. The memory 217 may comprise random access memory (RAM), dynamic random access memory (DRAM), electrically erasable programmable read-only memory (EEPROM), flash memory, etc. In one embodiment, the memory 217 may comprise RAM and Flash memory components.

The IMD 200 may also comprise a stimulation unit 220. The stimulation unit 220 is capable of generating and delivering a variety of electrical neurostimulation signals to one or more electrodes via leads. A number of lead assemblies 122 may be coupled to the IMD 200. Therapy may be delivered to the lead by the stimulation unit 220 based upon instructions from the controller 210. The stimulation unit 220 may comprise various types of circuitry, such as stimulation signal generators, and other circuitry that receives instructions relating to the type of stimulation to be performed. The stimulation unit 220 is capable of delivering a controlled current neurostimulation signal to the leads and to the electrodes. In one embodiment, the controlled current neurostimulation signal may refer to a prescribed or pre-determined current to a neural tissue of a patient.

The IMD 200 may also comprise a power supply 230. The power supply 230 may comprise a battery, voltage regulators, etc., to provide power for the operation of the IMD 200, including delivering stimulation. The power supply 230 may comprise a power-source battery that in some embodiments is rechargeable. The power supply 230 provides power for the operation of the IMD 200, including electronic operations and the stimulation function. The power supply 230, in one embodiment, may comprise a lithium/thionyl chloride cell or, more preferably, a lithium/carbon monofluoride (LiCFx) cell.

The IMD 200 also comprises a communication unit 260 capable of facilitating communications between the IMD 200 and various devices. In particular, the communication unit 260 is capable of providing transmission and reception of electronic signals to and from an external unit 270. The external unit 270 may be a device that is capable of programming various modules and stimulation parameters of the IMD 200. In one embodiment, the external unit 270 comprises a computer system that is capable of executing a data-acquisition program. The external unit 270 may be controlled by a medical professional, such as a physician, at a base station in, for example, a doctor's office. The external unit 270 may be a computer, preferably a handheld computer or PDA, but may alternatively comprise any other device that is capable of electronic communications and programming. The external unit 270 may download various parameters and program software into the IMD 200 for programming the operation of the implantable device. The external unit 270 may also receive and upload various status conditions and other data from the IMD 200. The communication unit 260 may comprise hardware, software, firmware, and/or any combination thereof. Communications between the external unit 270 and the communication unit 260 may occur via a wireless or other type of communication, illustrated generally by line 275 in FIG. 2. Various software and/or firmware applications may be loaded into the external unit 270 for programming the external unit 270 for communications with the IMD 200. In one embodiment, the external unit 270 may be controlled by Windows® CE operating system offered by Microsoft Corporation.

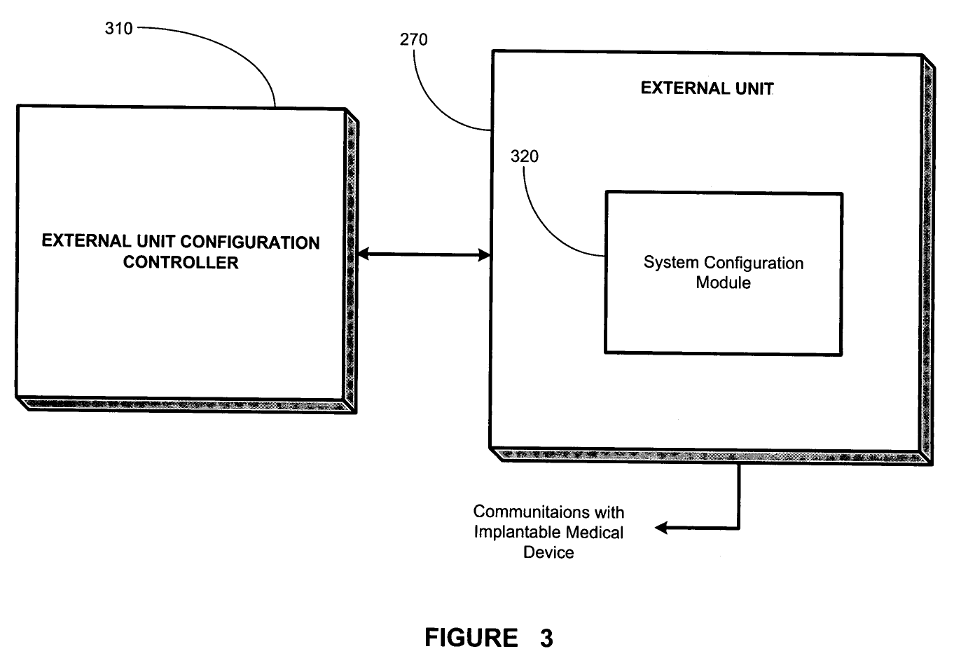

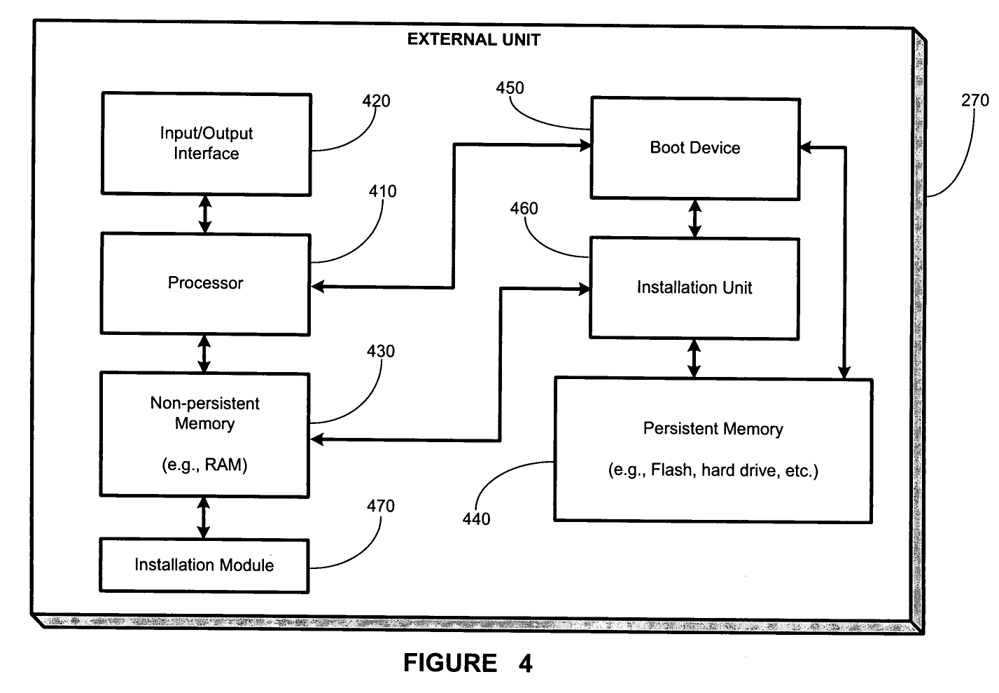

FIG. 3 illustrates an external unit 270 that comprises a system configuration module 320, in communication with an external unit configuration controller 310. In one embodiment, the external unit configuration controller 310 may be part of a computer system, which is capable of controlling the installation of a software and/or a firmware product into the external unit 270. Embodiments of the present invention may be used to control the operation of the system configuration module 320, such that a single .CAB file may be used to allow for software product installation into a variety of types of external units 270. More detailed description of the system configuration module 320 is provided below. Various types of external units 270 with different configurations may be controlled by a similar operating system, such as Windows® CE. External units 270 that operate on an operating system, such as Windows® CE operating system offered by Microsoft Corporation, may be originally configured such that each external unit 270 may comprise a different persistent memory configuration. Using embodiments of the present invention, a plurality of the differently configured external devices 270 may be prompted to install software products using a uniform .CAB file. A more detailed description of the external unit 270 is provided in FIG. 4 and the accompanying description below.

Turning now to FIG. 4, a more detailed block diagram depiction of the external unit 270 of FIGS. 2 and 3 is provided, in accordance with one illustrative embodiment of the present invention. The external unit 270 may comprise an input/output interface 420 that is capable of providing communications to and from an input/output device, e.g., the IMD 200, the external unit configuration controller 310, etc. Data to and/or from the input/output interface 420 may be processed by a processor 410, which is capable of controlling various operations performed by the external unit 270. The processor 410 may comprise one or more controller that contains an architecture offered by Intel Corp., Motorola, Inc., Apple Computer Corp., Advanced Micro Devices, Inc., Palm Inc., etc.

The external unit 270 may also comprise a non-persistent memory 430. The non-persistent memory 430 may refer to volatile memory, such as RAM, etc. The external unit 270 may also comprise a persistent memory 440. The persistent memory 440 may refer to non-volatile memory, such as flash memory, hard drive, etc. The external unit 270 may also comprise an installation module 470 that may be in communication with the non-persistent memory 430. The installation module 470 is capable of initiating an installation sequence and is described in greater detail below. Installation data may be sent to the non-persistent memory 430 before being installed into the persistent memory 440.

The external unit 270 may also comprise an installation unit 460. The installation unit 460 may comprise various installation media, such as a .CAB file. The .CAB file may comprise a plurality of files that may be extracted and invoked to perform installation of a software product into the external unit 270. The installation unit 460 generally comprises data and program files. The installation module 470 comprises the script, i.e., instructions to utilize the data and/or the program files. The combination of the installation unit 460 and the installation module 470 provides for the ability to perform self-extraction of the CAB files.

The external unit 270 may also comprise a boot device 450. The boot device 450 is capable of performing a boot up operation of the external unit 270. The boot device 450 is capable of communicating with the installation unit 460 to perform an installation of a software product into the external unit 270. In one embodiment, the boot device 450, the installation unit 460, and/or the installation module 470, may be portions of the system configuration module 320 of FIG. 3. Various portions of FIG. 4, such as the installation module 470, the boot device 450, the installation unit 460, the input/output interface 420, etc., may comprise software units, hardware units, firmware units, and/or any combination thereof.

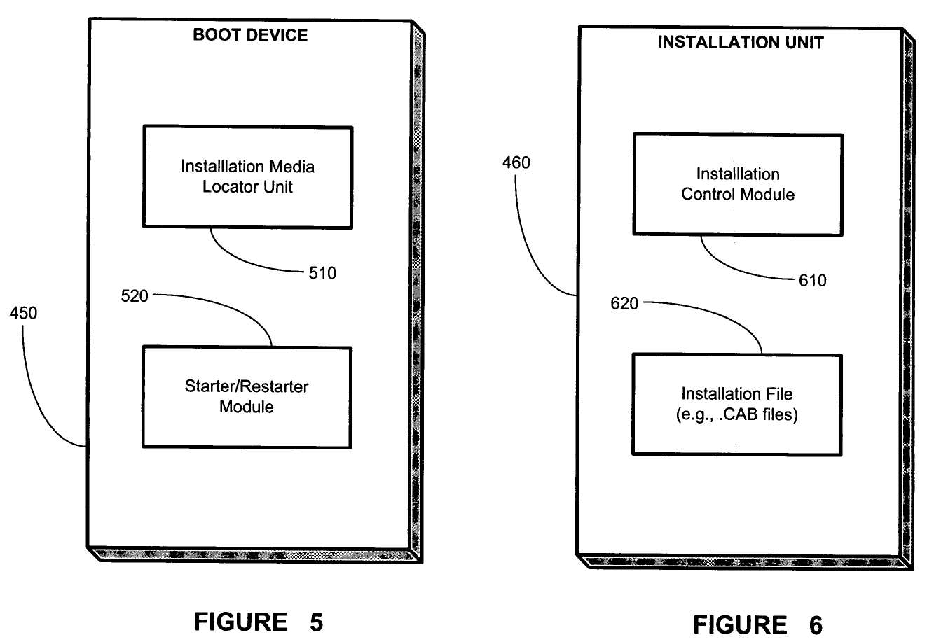

FIG. 5 provides a block diagram of the boot device 450, in accordance with one illustrative embodiment of the present invention. The boot device 450 may comprise an installation media locator unit 510. The installation media locator unit 510 is capable of scanning various portions of the external unit 270 in order to locate an installation media that may be used to perform an installation sequence for installing a software product. The boot device 450 may also comprise a starter/restarter module 520. Starter/restarter module 520 is capable of placing the external unit 270 into a reset and/or restart mode. The boot device 450 may be invoked by the external unit 270, which in turn, may be prompted by the external unit configuration controller 310 to initiate an installation sequence.

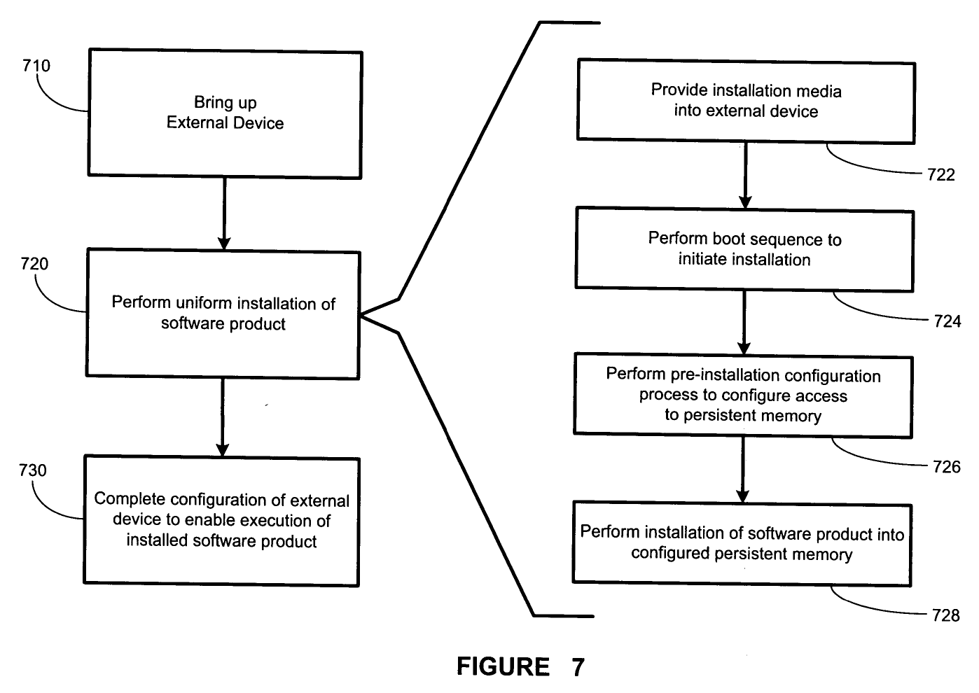

Turning now to FIG. 6, a more detailed illustration of the installation unit 460, in accordance with one illustrative embodiment of the present invention, is provided. The installation unit 460 may comprise an installation control module 610 and an installation file 620. The installation control module 610 is capable of executing scripts provided by the installation file 620. In one embodiment, the scripts refer to control parameters used to facilitates extraction of files read into memory and used as needed. The installation control module 610 is capable of extracting information (e.g., scripts) from the installation file 620 and performing executions based upon instructions to install a software product. The installation file 620 may comprise one or more files bundled into a file-set, such as a .CAB file, which may comprise a plurality of files. In one embodiment, the installation file 620 may comprise files that may be self-executing. In another embodiment, the installation file 620 may provide scripts to the installation control module 610 for execution.

Referring to FIG. 7, a flowchart of the method for performing software product installation is provided, in accordance with one illustrative embodiment of the present invention. Initially, the external unit 270 may be started up (block 710). The control of the external unit 270 may be performed by a manual operator/user or an external unit configuration controller 310. Upon bringing up the external unit 270, a uniform fashion installation of a software product may be performed in order to install the software product into the external units (block 720). The uniform installation process may refer to an installation process that may be used across a plurality of types of external units 270. For example, a uniform .CAB file may be used to install various software products into differently configured external units 270. The uniform installation process of block 720 may comprise various steps, as illustrated in blocks 722-728 of FIG. 7.

The uniform installation process may include providing installation media to the external unit 270 (block 722). The installation media may be used to install a software product that may be stored in the non-volatile (i.e., persistent) memory 430 in the external unit 270. The installation media may be downloaded into the external unit 270 via wireless or wired communication links. The uniform installation process may include performing a boot sequence to initiate the installation process (block 724). The initiation of the boot sequence may be prompted by a signal from the external unit configuration controller 310.

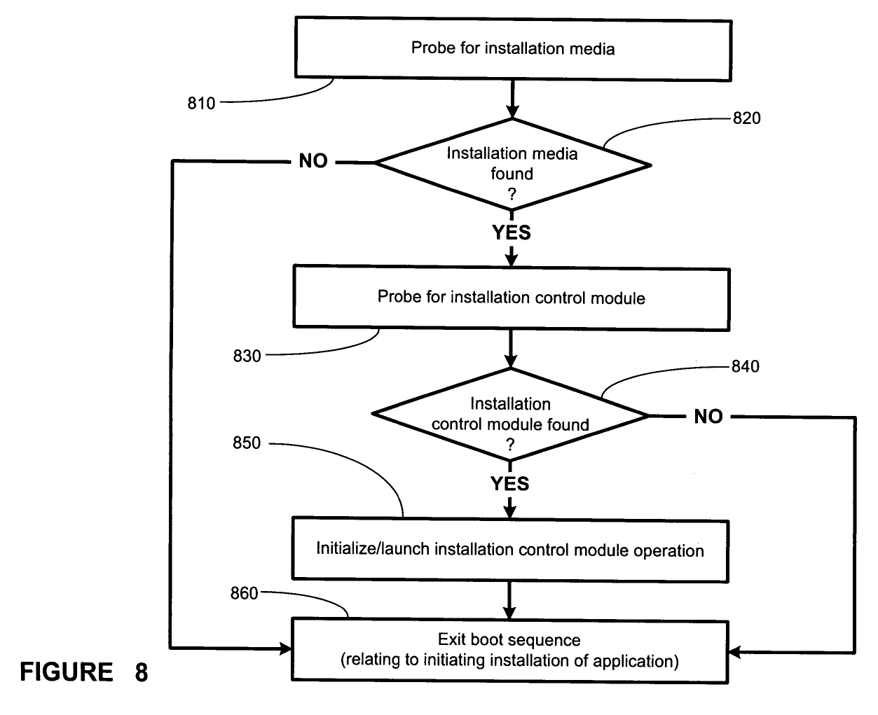

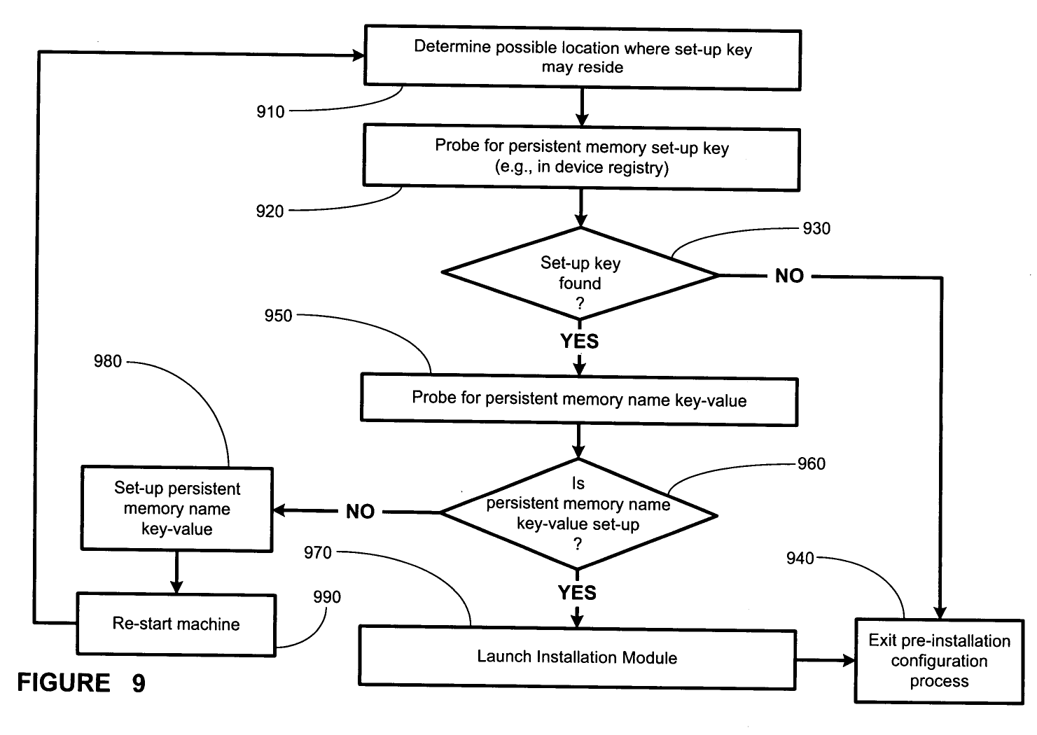

The boot sequence places the external unit 270 into a restart boot-up sequence. A more detailed description of the boot sequence of block 724 is provided in FIG. 8 and the accompanying description below. Upon initiating the boot-up sequence, a pre-installation configuration process may be performed (block 726). This process is performed to configure access to the persistent memory 440. A more detailed description of the pre-installation configuration process of block 726 is provided in FIG. 9 and the accompanying description below.

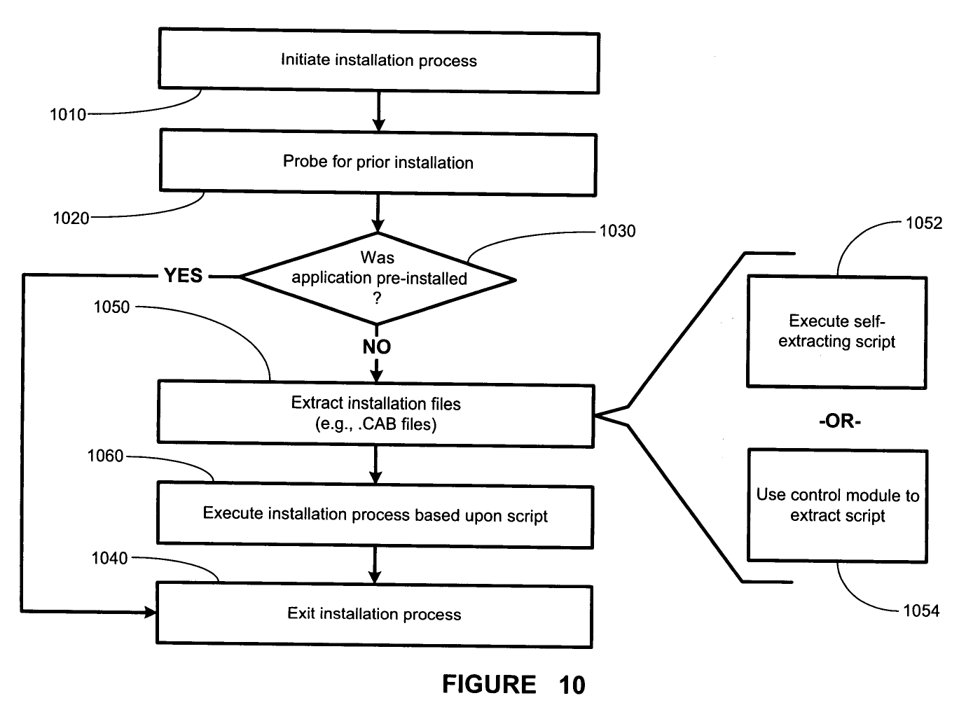

Once the pre-installation configuration process is performed and access to the persistent memory has been configured, an installation process for installing a software product into the configured portion of the persistent memory 440 is performed (block 728). A more detailed description of the installation process of block 728 is provided in FIG. 10 and the accompanying description below. Upon performing the installation of a software product, the configuration process is completed and the external unit 270 is capable of executing the installed software product (block 730). This may allow the external unit 270 to communicate with the IMD 200. This communication may include acquiring status data from the IMD 200, providing software code to the IMD 200, and/or controlling or affecting an operation of the IMD 200. The completion of the processes illustrated in FIG. 7 provides for a uniform and/or automated installation of software products into an external device 270 such that it would be capable of communicating and/or programming the IMD 200.

Referring to FIG. 8, there is provided a more detailed flowchart of the steps for performing a boot sequence to initiate the installation process described in block 724 of FIG. 7, in accordance with one illustrative embodiment of the present invention. The boot sequence may include a step of probing the external unit 270 for an installation media (block 810). For example, the processor 410 may initiate a search throughout various storage portions of the external unit 270 in order to locate the installation media. Alternatively, a user or the external unit configuration controller 310 may provide a signal or indication to the external unit 270 as to the location of the installation media. The installation media may comprise a number of files that may be organized into a .CAB file. The external unit 270 may then make a determination as to whether the installation media has been located (block 820). Upon a determination that the installation media has not been located, the boot sequence relating to initiating the installation process is exited (block 860).

Upon a determination (block 820) that the installation media has been found, the external unit 270 may then probe for the installation control module 610. A determination is made whether the installation control module 610 has been located (block 840). If the installation control module 610 has not been located, the boot sequence relating to the initiation of the installation of software product is exited, as indicated in FIG. 8. Subsequently, a message may be provided by the external unit 270 that the installation process has been interrupted. Upon a determination that the installation control module 610 has been located, the installation control module operation is initialized or launched (block 850). The launching of the installation control module operation relates to performing the pre-installation configuration process of block 726, which is described in further detail in FIG. 9 and accompanying description below.

Referring to FIG. 9, a block diagram is provided of the pre-installation configuration process of block 726 of FIG. 7, in accordance with one illustrative embodiment of the present invention. Upon initiation of the installation control module operation 850, a determination is made as to the possible location where a persistent memory set-up key may reside (block 910). Determining the possible location where the set-up key may reside may be based upon the specification of the operating system residing on the external unit 270, the device specification of the external unit 270, an automatic determination in response to a system diagnostic, and/or an input from an external source (e.g., external unit configuration controller 310). Based upon the possible locations identified as to where the set up key may reside, the external unit 270 may probe for the persistent memory set up key (block 920).

In one embodiment, the persistent memory set-up key may be found in the device registry. The set up key described above may provide an indication of how to access certain persistent memory locations 440. A determination is made as to whether the set-up key has been found (block 930). Upon a determination that the set-up key has not been found, the pre-installation configuration process is exited (block 940), and a message may then be provided by the external unit 270 indicating that the configuration process has been interrupted.

Upon a determination (block 930) that the set-up key has been found, a probe for the persistent memory name key-value is performed (block 950). Based upon the key-value, a portion of the persistent memory may be identified and accessed. Based upon the persistent memory name key-value, a particular block within the portion of the persistent memory 440 is sought. A determination is made whether the persistent memory name key-value has been found (block 960). When the key-value has been found, a block location of the persistent memory 440 is identified and the installation module is launched (block 970). A more detailed description of the launching of the installation module, which leads to the installation of the software product, as described in block 728 of FIG. 7, is provided in FIG. 10 and the accompanying description below.

Upon launching the installation module (block 970), the pre-installation configuration process is exited (block 940). Upon a determination (block 960) that the persistent memory name key-value has not been found, a set-up process of the persistent memory name key-value is initiated (block 980). In other words, if a first, existing persistent memory name key-value is not found, a second persistent memory name key-value may be generated to provide memory access. The set-up of the persistent memory name key-value involves reconfiguring the entire external unit 270 to set a link as to how the persistent memory 440 is accessed. In one embodiment, the set-up of the persistent memory name key-value (block 980) may be performed using the set-up key located at block 930. Accordingly, embodiments of the present invention provide for configuring the system of the external unit 270 in order to install a software product. Upon the set up of the persistent memory name key-value 980, the external unit 270 may be restarted (block 990). Upon restarting of the machine, the probe for persistent memory set up key and subsequent blocks of FIG. 9 may be repeated until the key-value is set up and the install module is launched. Therefore, upon completion of the steps described in FIG. 9, the pre-installation configuration process is substantially complete and the external unit 270 would now be ready to allow for installation of software products in its non-volatile/persistent memory.

In FIG. 10, a flowchart depiction of the steps for performing the installation process of block 728 in FIG. 7 is provided, in accordance with one illustrative embodiment of the present invention. The installation process is initiated (block 1010) upon completion of the pre-installation configuration process 726. Subsequently, the installation module 470 probes for prior installation of the software product of interest (block 1020). A determination is made as to whether the software product of interest has been pre-installed (block 1030). Upon a determination that the software product has been pre-installed, the installation process is exited (block 1040).

Upon a determination (block 1030) that the software product of interest has not been pre-installed, the installation module 470 may extract installation files from the installation media (block 1050). This may include extracting the .CAB files, as well as the various files within the .CAB files (e.g., scripts). Extracting the installation files 1050 may involve executing a self-extracting script (block 1052). This process may provide for an automated self-executing software program that drives the installation process. Alternatively, the installation control module 610 may extract the various scripts from the installation media, such as from the .CAB files (block 1054).

Upon extraction of the installation files, the installation module 470 executes the installation process based upon the script (block 1060). Therefore, depending on the type of software product to be installed, the pre-determined scripts provide instructions to the installation control module 610 to perform certain tasks. Subsequent to the execution of the installation process 1060 based on the script, the installation process is exited (block 1040). At this point, the software product of interest has been installed into the external unit 270 in a uniform fashion. In other words, the installation process provided herein may be used to install a software product into various external units 270, each having a different configuration. In one embodiment, a common operating system among the various external devices 270, (e.g., Windows® CE) may be used to facilitate the uniform installation of a software product. Therefore, the same .CAB file may be used to install the software product across a variety of types of external units 270. In one embodiment, the present invention is employed in conjunction with an operating system offered by Microsoft Corp. However, concepts provided by embodiments of the present invention may be performed in relation to a plurality of operating systems and configurations of external unit 270.

Utilizing embodiments of the present invention, an efficient method, system, and apparatus are provided for installing software products into an external device, such as a handheld device. Therefore, using uniform methods of installing the software product into various external units 270, communication and other various types of interaction between the external unit 270 and the IMD 200 may be facilitated. Utilizing embodiments of the present invention, an efficient, uniform method of installing software into various devices is provided, thereby providing improved manufacturing of implantable systems and peripheral devices more efficient.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular embodiments disclosed above may be altered or modified and all such variations are considered within the scope and spirit of the invention. Accordingly, the protection sought herein is as set forth in the claims below.

What is claimed:

1. A method for installing an application into a device, comprising:
locating a control access parameter relating to a persistent memory of said device;
defining a portion of said persistent memory using said control access parameter to provide a defined portion of said persistent memory; and
installing said application into said defined portion of said persistent memory.

2. The method of claim 1, wherein locating said control access parameter relating to said persistent memory comprises locating a set-up key relating to said persistent memory.

3. The method of claim 2, wherein locating said set-up key relating to said persistent memory comprises locating said set-up key based upon at least one of a specification relating to an operating system residing in said device, a specification relating to a configuration of said device, and a scan performed in said persistent memory.

4. The method of claim 2, wherein defining said portion of said persistent memory using said control access parameter comprises:
determining whether a first persistent memory name key-value is found,; and
generating a second persistent memory name key-value comprising data relating to an identification of a portion of said persistent memory in response to a determination that said first persistent memory name key-value is not found.

5. The method of claim 4, wherein defining said second persistent memory name key-value comprises using said set-up key to define said second persistent memory name key-value.

6. The method of claim 1, wherein installing said application into said defined portion of said persistent memory comprises launching an installation cabinet file to install said application into said defined portion of said persistent memory.

7. The method of claim 6, wherein launching said installation cabinet file comprises launching said installation cabinet file that is compatible with a Microsoft Windows® operating system.

8. The method of claim 1, further comprising resetting said device prior to locating said control access parameter relating to a persistent memory of said device.

9. The method of claim 1, wherein installing said application into said defined portion of said persistent memory comprises determining whether said application has been pre-installed in said device and launching an installation file in response to determining that said application has not been pre-installed.

10. A method for installing an application into a device, comprising:
performing a boot sequence of said device;
performing a pre-installation configuration operation for said device comprising locating a set-up key relating to a non-volatile memory of said device and using said set-up key to define a named portion of said non-volatile memory; and
installing said application into said named portion of said non-volatile memory.

11. The method of claim 10, wherein performing a boot sequence of said device comprises:
locating an installation media for installing said application;
locating a control module capable of performing said pre-installation configuration; and
launching said control module to perform said pre-installation configuration.

12. The method of claim 10, wherein using said set-up key to define a named portion of said non-volatile memory comprises setting a non-volatile memory name key-value using said set-up key.

13. The method of claim 12, further comprising restarting said device in response to setting said non-volatile memory device name key-value.

14. An external device for communicating with an implantable medical device, comprising:
an input/output device to receive an instruction to install an application into said external device;
a non-volatile memory to receive an installation of said application; and
a controller to perform said installation of said application into said external device, said controller to locate a set-up key associated with said non-volatile memory, said controller to also assign a memory name key-value to a portion of said non-volatile memory using said set-up key and install said application into said portion of said non-volatile memory.

15. The external device of claim 14, further comprising a boot device to perform a boot sequence upon said external device, said boot sequence comprising locating an installation media for installing said application, and locating an installation unit capable of launching said control module capable of performing said pre-installation configuration.

16. The external device of claim 14, wherein said application installed into said external device provides for communications between said external device and said implantable medical device.

17. The external device of claim 14, wherein external device is at least one of a handheld device and a portable device.

18. An implantable medical device system, comprising:
an implantable medical device capable for providing at least one of an electrical and an electromagnetic stimulation to a portion of a patient's body; and
an external device capable of communications with said implantable medical device, said external device comprising:
an input/output device to receive an instruction to install an application into said external device, said application providing for communications between said implantable medical device and said external device;
a non-volatile memory to receive an installation of said application; and
a controller to perform said installation of said application into said external device, said controller to locate a set-up key associated with said non-volatile memory, said controller to also assign a memory name key-value to a portion of said non-volatile memory using said set-up key, and install said application into said portion of said non-volatile memory.

19. A computer readable program storage device encoded with instructions that, when executed by a computer, performs a method for installing an application into a device, comprising:
locating a control access parameter relating to a persistent memory of said device;
defining a portion of said persistent memory using said control access parameter to provide a defined portion of said persistent memory; and
installing said application into said defined portion of said persistent memory.

20. The computer readable program storage device of claim 19, wherein locating said control access parameter relating to said persistent memory comprises locating a set-up key relating to said persistent memory.

21. The computer readable program storage device of claim 20, wherein locating said set-up key relating to said persistent memory comprises locating said set up key based upon at least one of a specification relating to an operating system residing in said device, a specification relating to a configuration of said device, and a scan performed in said persistent memory.

22. The computer readable program storage device of claim 20, wherein defining said portion of said persistent memory using said control access parameter comprises:
determining whether a first persistent memory name key-value is found; and
generating a second persistent memory name key-value comprising data relating to an identification of a portion of said persistent memory in response to a determination that said first persistent memory name key-value is not found.

23. The computer readable program storage device of claim 22, wherein defining said second persistent memory name key-value comprises using said set-up key to define said second persistent memory name key-value.

24. The computer readable program storage device of claim 19, wherein installing said application into said defined portion of said persistent memory comprises launching an installation cabinet file that is compatible with a Microsoft Windows operating system.
